(19) United States
(12) Patent Application Publication
(10) Pub. No.: US 2012/0050029 A1
(43) Pub. Date: Mar. 1, 2012

(54) PROGRAMMABLE TIRE MONITORING DEVICE AND ITS METHOD OF USE

(76) Inventors: San-Chuan YU, Fusing Township (TW); Yuan-Tung Hung, Changhua County (TW); Chao-Ching Hu, Tainan County (TW)

(21) Appl. No.: 12/870,574

(22) Filed: Aug. 27, 2010

(51) Int. Cl. B60C 23/02

(52) U.S. Cl. 340/447; 340/442

(57) ABSTRACT

A programmable tire monitoring device includes a casing having an air nozzle on its one end and a set of pin-connection holes and a switch hole on its top side, a circuit board mounted in the casing and carrying a processor and a memory, a pressure sensor and a temperature sensor and an acceleration sensor electrically connected to the processor for sensing the pressure, temperature and acceleration of one tire of a car, a transmission interface for transmitting the measured data to a receiver in the car, a connection port installed in the circuit board corresponding to the pin-connection holes for enabling the circuit board to be connected with an external electrical connector, a battery set for providing the programmable tire monitoring device with the necessary electric power, a voltage sensor electrically connected to the processor for sensing the voltage of the battery set, and a power switch for switching on/off the circuit of the battery set. The invention relates also to the method of using the programmable tire monitoring device.

### BACKGROUND OF THE INVENTION

1. Field of the Invention

The present invention relates to tire pressure measuring technology and more particularly, to a programmable tire monitoring device and its method of use.

2. Description of the Related Art

The tires of many commercial cars have a respective tire monitoring device installed therein to measure the tire temperature and the tire pressure and to provide the measured data to the driver for reference, enhancing driving safety. However, commercial tire monitoring devices are still not satisfactory in function. Because every supplier provides a specific coding method, these commercial tire monitoring devices have the characteristics of unique and specificity, i.e., one model of product simply fit the cars from one manufacturer or the cars of one or two models. This limitation complicates further maintenance work and inventory control.

There are commercial wireless or programmable tire-pressure monitoring devices that allow installation of multiple programs in the memory. However, the limited storage space of the memory and the processing ability of the processor do not allow these commercial wireless or programmable tire-pressure monitoring devices to fit all commercial cars. Further, when programming in a wireless manner, the transmission of wireless data is not directional, i.e., the signal cannot be exclusively sent to the tire-pressure monitoring device in one specific tire of a car. During operation, the tire-pressure monitoring devices in the other tires of the car or in the tires of other cars in the surroundings may receive the signal and be encoded. Coding through a wired transmission method assures high stability and reliability, allowing repeatedly programming. Further, this method is free from the constraint of memory space. Further, commercial tire-pressure monitoring devices are commonly equipped with a battery set to provide the necessary working voltage. However, these tire-pressure monitoring devices do not allow the user to switch on/off the battery set freely, and therefore the battery set keeps supplying electric power either the tire-pressure monitoring device is in work or not in work, causing possible power loss, leakage of battery fluid or battery corrosion. Further, when writing a program, it is preferably to cut off power supply from the operating circuit of the tire-pressure monitoring device, assuring writing stability and success. However, commercial tire-pressure monitoring devices cannot meet this requirement.

### SUMMARY OF THE INVENTION

The present invention has been accomplished under the circumstances in view. It is the main object of the present invention to provide a programmable tire monitoring device and its method of use, which has the advantages of easy of use and high accuracy and reliability.

To achieve this and other objects of the present invention, a programmable tire monitoring device comprises a casing having an air nozzle on its one end and a set of pin-connection holes and a switch hole on its top side, a circuit board mounted in the casing and carrying a processor and a memory, a pressure sensor and a temperature sensor and an acceleration sensor electrically connected to the processor for sensing the pressure, temperature and acceleration of one tire of a car, a transmission interface for transmitting the measured data to a receiver in the car, a connection port installed in the circuit board corresponding to the pin-connection holes for enabling the circuit board to be connected with an external electrical connector, a battery set for providing the programmable tire monitoring device with the necessary electric power, a voltage sensor electrically connected to the processor for sensing the voltage of the battery set, and a power switch for switching on/off the circuit of the battery set.

To achieve this and other objects of the present invention, a method of using a programmable tire monitoring device comprises the steps of: a) preparing a programmable tire monitoring device and a hand-control tool, wherein the programmable tire monitoring device comprises a casing, a circuit board mounted in the casing and carrying a processor and a memory, a connection port installed in the casing and electrically connected to the processor and memory of the circuit board and a battery set adapted for providing the circuit board with the necessary electric power; b) cutting off the electric power of the battery set from the circuit board and then electrically connecting an electrical connector of said hand-control tool to said connection port; and c) operating said hand-control tool to write the desired coding program and communication protocol into said programmable tire monitoring device, and then disconnecting the connector from the connection port, and then electrically connecting the battery set to provide electric power to the circuit board, and then installing the programmable tire monitoring device in a vehicle tire.

### BRIEF DESCRIPTION OF THE DRAWINGS

FIG. 1 is a schematic exploded view of a programmable tire monitoring device in accordance with the present invention.

FIG. 2 is a circuit block diagram of the present invention.

### DETAILED DESCRIPTION OF THE INVENTION

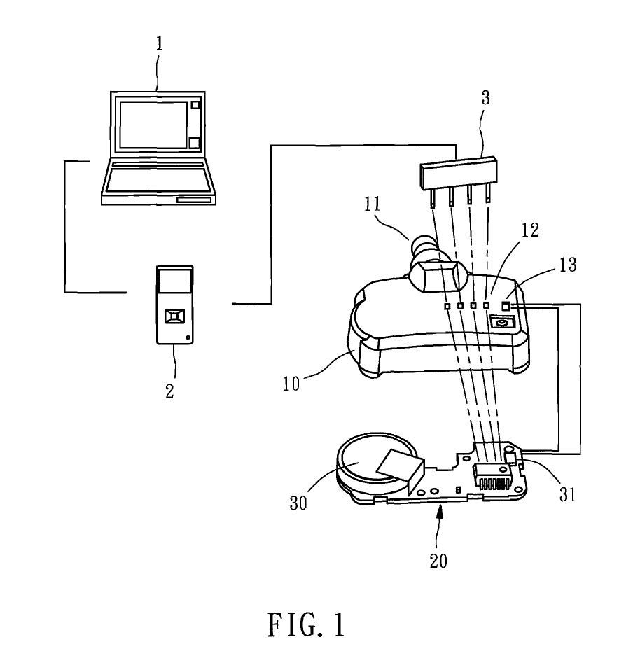

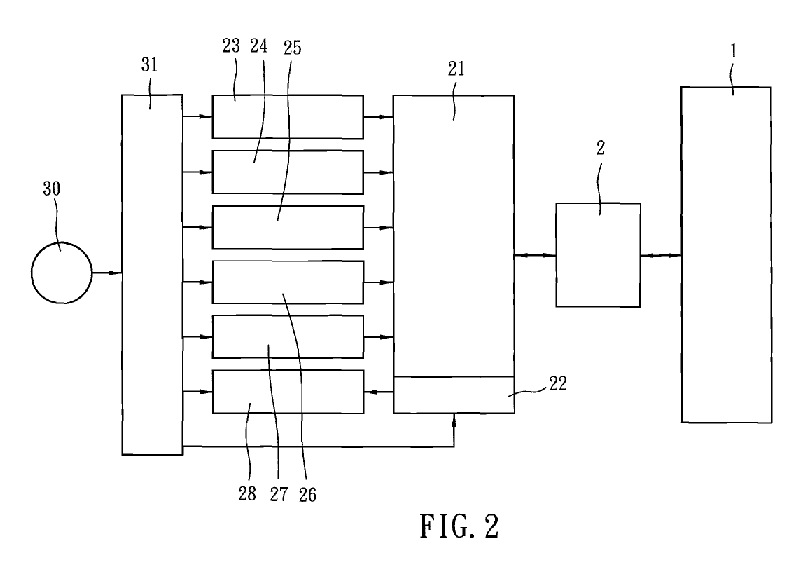

Referring to FIGS. 1 and 2, a programmable tire monitoring device in accordance with the present invention is shown for use in a car, comprising a casing 10, which has an air nozzle 11 located on one end thereof and a set of pin-connection holes 12 and a switch hole 13 located on the top side thereof, a circuit board 20 mounted inside the casing 10 and carrying a processor 21 and a memory 22 that is an electrically erasable programmable read/write memory, a pressure sensor 23 electrically connected to the processor 21 and adapted for sensing the internal pressure of one tire of the car, a temperature sensor 24 electrically connected to the processor 21 and adapted for sensing the internal temperature of the same tire, an acceleration sensor 25 electrically connected to the processor 21 and adapted for sensing the acceleration of the tire, a LF (Low Frequency) transmission interface 27 and a RF (Radio Frequency) transmission interface 28 respectively electrically connected to the processor 21 and adapted for transmitting the measured data to a receiver in the car by LF (Low Frequency) or RF (Radio Frequency), a connection port 29 installed in the circuit board 20 corresponding to the pin-connection holes 12 for enabling the circuit board 20 to be connected with an external electrical connector, a battery set 30 adapted for providing the programmable tire monitoring device with the necessary electric power, a voltage sensor 26 electrically connected to the processor 21 and adapted for sensing the voltage of the battery set 30, and a power switch 31 mounted in the switch hole 13 and electrically connected to the circuit board 20 and adapted for switching on/off the connection between the battery set 30 and the circuit board 20.

Referring to FIG. 1 again, the programmable tire monitoring device must be used with an external computer 1, a hand-control tool 2 and an electrical connector 3.

The electrical connector 3 is connected to the connection port 29 for communication with the external computer 1 via the hand-control tool 2. The electrical connector 3 can be connected to the hand-control tool 2 by a cable. When the external computer 1, the hand-control tool 2, the electrical connector 3 and the connection port 29 of the programmable tire monitoring device are electrically connected, the user can operate the hand-control tool 2 to write the necessary coding program and transmission protocol into the programmable tire monitoring device. After writing of the coding program and transmission protocol, remove the electrical connector 3 from the programmable tire monitoring device, and then switch on the power switch 31, and then install the programmable tire monitoring device in the tire of the car to start working.

When wishing to change the coding program and transmission protocol, remove the programmable tire monitoring device from the tire of the car, and then switch off the power switch 31, and then connect the electrical connector 3 to the connection port 29 at the pin-connection holes 12, and then operate the hand-control tool 2 to write the new coding program and transmission protocol into the programmable tire monitoring device. The user can erase the original coding program and transmission protocol and then write the new coding program and transmission protocol into the programmable tire monitoring device. Alternatively, the user can overlap the new coding program and transmission protocol on the original coding program and transmission protocol. Thus, the programmable tire monitoring device can be used in a new model of car, i.e., the programmable tire monitoring device is programmable to fit different cars.

According to the present preferred embodiment, the user can operate the power switch 31 to switch on/off the power supply of the programmable tire monitoring device. Further, the power switch 31 is a manual switch. In an alternate form of the present invention, the programmable tire monitoring device can be configured in such a manner that the power supply of the programmable tire monitoring device can be switched on/off by means of the hand-control tool 2. After connection of the electrical connector 3 to the hand-control tool 2, the user can operate the hand-control tool 2 to switch on/off the power supply of the programmable tire monitoring device.

The structure of the invention involves the characteristics of unique and specificity. Only the programmable tire monitoring device to which the electrical connector is connected allows removal of the installed coding program and communication protocol or writing of a new coding program and communication protocol, avoiding coding program and communication protocol erasing or writing mistake. Further, the power supply of the programmable tire monitoring device can be switched off when erasing the installed coding program and communication protocol or writing a new coding program and communication protocol, assuring writing stability and success. Further, when keeping in the inventory, the power supply of the programmable tire monitoring device can be switched off, avoiding possible power loss, leakage of battery fluid or battery corrosion.

What is claimed is:

1. A programmable tire monitoring device for use in a vehicle, comprising:
a casing having an air nozzle located on one end thereof and a set of pin-connection holes and a switch hole located on a top side thereof;
a circuit board mounted inside said casing and carrying a processor and an electrically erasable programmable read/write memory;
a pressure sensor electrically connected to said processor and adapted for sensing the internal pressure of a tire of the vehicle;
a temperature sensor electrically connected to said processor and adapted for sensing the internal temperature of the same tire;
an acceleration sensor electrically connected to said processor and adapted for sensing the acceleration of the same tire;
transmission interface means adapted for transmitting the measured data to a receiver in the vehicle
a connection port installed in said circuit board corresponding to said pin-connection holes for enabling said circuit board to be connected with an external electrical connector;
a battery set adapted for providing the programmable tire monitoring device with the necessary electric power;
a voltage sensor electrically connected to said processor and adapted for sensing the voltage of said battery set; and
a power switch adapted for switching on/off the connection between said battery set and said circuit board.

2. The programmable tire monitoring device as claimed in claim 1, wherein said transmission interface means is a LF (Low Frequency) transmission interface.

3. The programmable tire monitoring device as claimed in claim 1, wherein said transmission interface means is a RF (Radio Frequency) transmission interface.

4. The programmable tire monitoring device as claimed in claim 1, wherein said transmission interface means comprises a LF (Low Frequency) transmission interface and a RF (Radio Frequency) transmission interface.

5. A method of using a programmable tire monitoring device, comprising the steps of:
a) preparing a programmable tire monitoring device and a hand-control tool, said programmable tire monitoring device comprising a casing, a circuit board mounted in said casing and carrying a processor and a memory, a connection port installed in said casing and electrically connected to said processor and said memory of said circuit board and a battery set adapted for providing said circuit board with the necessary electric power;
b) cutting off the electric power of said battery set from said circuit board and then electrically connecting an electrical connector of said hand-control tool to said connection port; and
c) operating said hand-control tool to write the desired coding program and communication protocol into said programmable tire monitoring device, and then disconnecting said connector from said connection port, and then electrically connecting said battery set to provide electric power to said circuit board, and then installing said programmable tire monitoring device in a vehicle tire.

6. The method as claimed in claim 5, further comprising a sub-step of operating said hand-control tool to erase the originally installed coding program and communication protocol from said programmable tire monitoring device prior to step c).

7. The method as claimed in claim 5, wherein said step c) is to overlap the desired coding program and communication protocol on the originally installed coding program and communication protocol in said programmable tire monitoring device.

8. The method as claimed in claim 5, wherein the step b) of cutting off the electric power of said battery set from said circuit board is directly done through said hand-control tool after connection of said electrical connector to said connection port.

9. The method as claimed in claim 5, wherein the step b) of cutting off the electric power of said battery set from said circuit board is done manually by the user.

10. The method as claimed in claim 5, wherein the step b) of cutting off the electric power of said battery set from said circuit board is to switch off a power switch that is installed in said casing of said programmable tire monitoring device for controlling the connection between said circuit board and said battery set.

11. The method as claimed in claim 10, wherein the step b) of cutting off the electric power of said battery set from said circuit board is directly done through said hand-control tool after connection of said electrical connector to said connection port.

12. The method as claimed in claim 10, wherein the step b) of cutting off the electric power of said battery set from said circuit board is done manually by the user.
